(19) United States
(12) Patent Application Publication
(10) Pub. No.: US 2007/0201385 A1
(43) Pub. Date: Aug. 30, 2007

(54) Apparatus, method, and computer product for topology-information collection

(75) Inventors: Ichiro Goto, Kawasaki (JP); Kazushi Tsunekawa, Kawasaki (JP); Kadohito Ohsuga, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/438,799

(22) Filed: May 22, 2006

(30) Foreign Application Priority Data
Feb. 24, 2006 (JP) 2006-048596

(51) Int. Cl. H04L 12/28; H04L 12/56

(52) U.S. Cl. 370/254; 370/409

(57) ABSTRACT

A network managing apparatus detects a router capable of using Telnet from among nodes in a network and causes that router to send a broadcast ping to other nodes. Each node in the network returns a ping reply to the router. The ping and the ping reply pass through a switch before arriving at their destinations. When the ping and the ping reply pass thorough the switch, the switch extracts MAC addresses of sender nodes and store them in its MAC address table. Thus, accurate topology of the network can be obtained from the MAC address table of the switch.

### BACKGROUND OF THE INVENTION

1. Field of the Invention

The present invention generally relates to a technology for collecting information on the topology of a network. The present invention specifically relates to a technology for collecting information on the topology of a network that includes at least an intermediate node having an address table containing address information of almost all nodes in the network.

2. Description of the Related Art

In recent years, it has become common to arrange a network managing apparatus in large-scale networks to manage the networks. Such a network managing apparatus includes a display monitor on the screen of which are displayed network topology and configuration to facilitate grasping of network failures due to various types of setting errors, disconnection, power cut, and load concentration on the network.

For example, Japanese Patent Applications Laid-Open Nos. H09-186716 and H11-068814 disclose conventional techniques. In the conventional techniques, a network managing apparatus learns the topology of the network by acquiring link information between respective nodes in a network, and creates a topology (network configuration) map based on the learnt topology. The link information is obtained from the media access control (MAC) address that uniquely identifies each node.

The MAC addresses of the nodes are acquired from an intermediate node having a switching function, such as a switch. The intermediate node holds a MAC address table. When the intermediate node relays a packet, the MAC address of the sender node of the packet and the port number of a connection port used for receiving the packet are written in associated manner in the MAC address table. This system enables high-speed communication between the nodes.

In the conventional technique, when there is no communication with some particular node for some time, information corresponding to that node is automatically deleted from the MAC address table as a result of aging. If the information corresponding to nodes is deleted from the MAC address table, however, the network managing apparatus cannot obtain an accurate topology of a low-traffic link by only referring to the MAC address table of the intermediate node.

Besides, according to the method of collecting topology information described in Japanese Patent Application Laid-Open No. H11-068814, each intermediate node in a network autonomously transmits a recognition signal to adjacent nodes at regular intervals. The MAC addresses of all the intermediate nodes through which the signal has passed are included in the recognition signal. Although this technique has an advantage that information in the MAC address table is not deleted, there is a disadvantage that every intermediate node in the network needs to have a mechanism for processing the recognition signal. Such a configuration leads to higher communication traffic and higher costs for the intermediate node so that the disadvantage becomes prominent as the size of the network increases.

### SUMMARY OF THE INVENTION

It is an object of the present invention to at least partially solve the problems in the conventional technology.

According to an aspect of the present invention, a topology information collecting apparatus that collects information on the topology of a network including at least an intermediate node having an address table, which contains address information of substantially all nodes in the network, and from which is deleted address information of a node that has not performed communication for a predetermined time period, the nodes including at least one router, includes a router detecting unit that detects a router from among the nodes; a broadcasting unit that causes detected router to broadcast, in the network, via the intermediate node echo-request packets each requiring an echo-reply packet so that the intermediate node stores in a corresponding address table address information of the detected router and address information of a sender node of an echo-reply packet; and a node-information collecting unit that collects address information from the address table of the intermediate node before the address information is deleted from the address table due to elapse of the predetermined time period.

According to another aspect of the present invention, a method of collecting information on the topology of a network including at least an intermediate node having an address table, which contains address information of substantially all nodes in the network, and from which is deleted address information of a node that has not performed communication for a predetermined time period, the nodes including at least one router, includes detecting a router from among the nodes; causing detected router to broadcast, in the network, via the intermediate node echo-request packets each requiring an echo-reply packet so that the intermediate node stores in a corresponding address table address information of the detected router and address information of a sender node of an echo-reply packet; and collecting address information from the address table of the intermediate node before the address information is deleted from the address table due to elapse of the predetermined time period.

According to still another aspect of the present invention, a computer-readable recording medium stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining how a network managing apparatus according to an embodiment of the present invention collects topology information of a network;

FIG. 2 is a detailed functional block diagram of the network managing apparatus shown in FIG. 1;

FIG. 3A is an example of contents of a routing table;

FIG. 3B is an example of information about an interface;

FIG. 4 is an example of contents of the MAC address table in a switch shown in FIG. 1;

FIG. 5 is a flowchart of a topology-map creation process performed by the network managing apparatus;

FIG. 6 is a detailed flowchart of a topology analysis process shown in FIG. 5;

FIG. 7 is a detailed flowchart of a broadcasting process shown in FIG. 6;

FIG. 8 is a detailed flowchart of a node-information collection process shown in FIG. 6; and

FIG. 9 is a detailed functional block diagram of a computer that realizes the various processes according to the embodiment.

### DETAILED DESCRIPTION OF THE PREFERRED EMBODIMENTS

Exemplary embodiments of the present invention are explained below in detail with reference to the accompanying drawings.

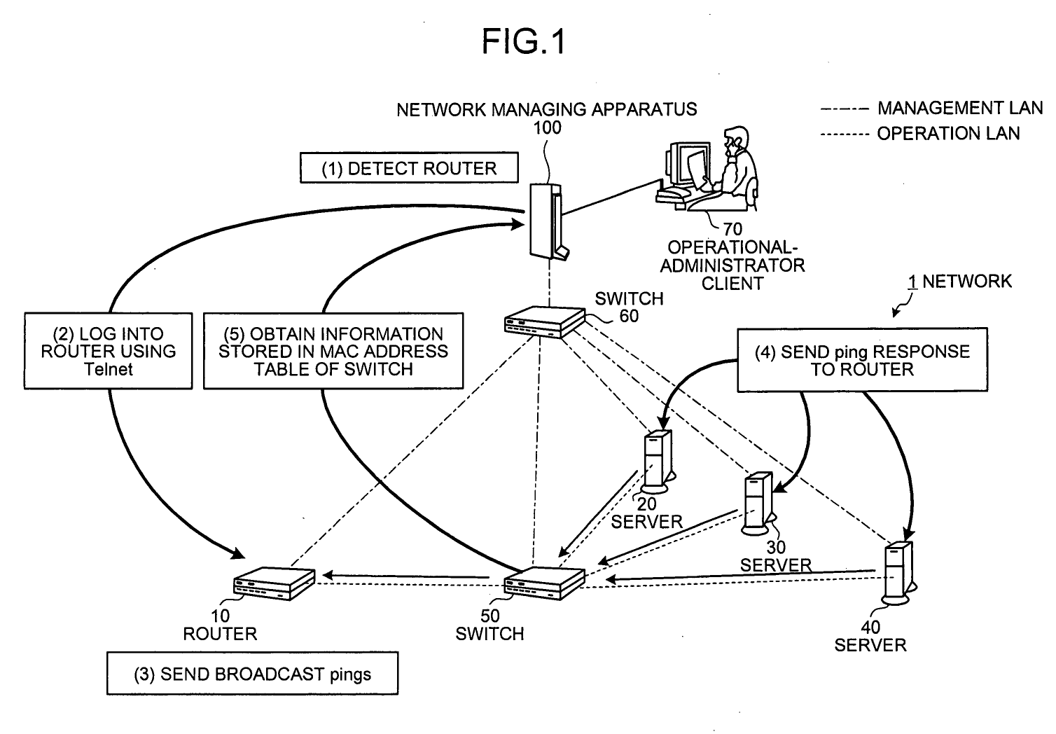

FIG. 1 is a schematic for explaining how a network managing apparatus 100 according to an embodiment of the present invention collects topology information of a network 1. The network 1 includes a plurality of nodes such as a router 10, a plurality of servers 20 to 40, and plurality of switches 50 and 60. The network managing apparatus 100 collects link information between nodes through a switch, for example, the switch 60, to learn the topology of the network 1 based on the information. The network managing apparatus 100 then creates a topology (network configuration) map and outputs the map to an operational-administrator client 70. The network managing apparatus 100 functions as a topology information collecting apparatus.

In FIG. 1, alternate long and short dash lines connecting the network managing apparatus 100 via the switch 60 to the respective nodes (router 10, servers 20 to 40, and switch 50) in the network 1 represent local area networks (LANs) used by the operational-administrator client 70 to manage the network 1. Besides, dashed lines extending from the switch 50 to the router 10 and the respective servers 20 to 40 represent LANs, which form the network 1, used for general network communication. Hereinafter, the LAN indicated by the alternate long and short dash line is referred to as a management LAN, while that indicated by the dashed line is referred to as an operation LAN.

The switch 50 includes a MAC address table. The network managing apparatus 100 obtains information stored in the MAC address table (not shown). Although only one switch, i.e., the switch 50, is shown, there can be a plurality of such switches. The network managing apparatus 100 collects information from all switches in the network 1 to obtain link information between the respective nodes. Incidentally, the switch 50 is a Layer 2 switch capable of determining the destination of a packet based on information about the data-link layer (Layer 2) in the header of a packet.

When the switch 50 receives a packet from a node in the network 1, the switch 50 extracts a MAC address that identifies the sender node from the packet and writes the extracted MAC address in its own MAC address table. Moreover, the switch 50 writes the port number of a connection port, through which the switch 50 has received the packet, in association with the MAC address in the MAC address table. Referring to the MAC address in the MAC address table, the switch 50 determines a connection port to be used to forward the packet.

Information in the MAC address table is maintained for a predetermined time period. If there is no communication with a certain node for the predetermined time period, information corresponding to that node is aged out of, i.e., deleted from, the MAC address table. Consequently, when there is no communication on the operation LAN for the predetermined time period, the relevant information is deleted from the MAC address table of the switch 50 so that the network managing apparatus 100 cannot obtain link information on the operation LAN by only communicating with the nodes through the management LANS.

To solve the problem, the network managing apparatus 100
(1) detects the router 10 before collecting link information in the network 1 (see (1) in FIG. 1),
(2) remotely logs into the router 10 through a teletype network (Telnet) (see (2) in FIG. 1),
(3) referring to the routing table of the router 10, controls the router 10 to broadcast packet Internet gropers (pings) or Internet control message protocol (ICMP) echo requests to a network (subnet), in which the servers 20 to 40 and the switch 50 reside, connected to the router 10 via the operation LAN (see (3) in FIG. 1).

Accordingly, the router 10 sends a ping to all other nodes in the network 1, i.e., the servers 20 to 40 and the switch 50. The servers 20 to 40 receive the ping via the switch 50.

Having received the pings from the router 10, the switch 50 associates the MAC address of the router 10 with the port number of a connection port that connects the switch 50 to the router 10 and temporarily stores the associated pair in the MAC address table.

On receipt of the ping via the switch 50, (4) each of the servers 20 to 40 sends a ping reply to the router 10 along the same path that carried the incoming ping (see (4) in FIG. 1). That is, similarly to the pings from the router 10, the ping replies from the servers 20 to 40 arrive at the router 10 via the switch 50.

Having received the ping replies from the servers 20 to 40, the switch 50 associates the MAC addresses of the servers 20 to 40 with the port numbers of connection ports connected to the servers 20 to 40, respectively, and temporarily stores the MAC addresses and the port numbers in the MAC address table.

Finally, (5) the network managing apparatus 100 obtains the information temporarily stored in the MAC address table of the switch 50 before the information is aged out of the table due to the elapse of the predetermined time period (see (5) in FIG. 1). Based on the information, the network managing apparatus 100 checks links between the switch 50 and the router 10, the switch 50 and the server 20, the switch 50 and the server 30, and the switch 50 and the server 40 through the operation LANs.

The network managing apparatus 100 creates a topology map of the network 1 consisting of operation-LAN links based on the information obtained from the switch 50. The network managing apparatus 100 then displays the topology map on the display screen of the operational-administrator client 70.

As described above, the network managing apparatus 100 detects the router 10 in the network 1 and causes the detected router 10 to send a broadcast ping to the other nodes via the switch 50 so that MAC addresses of even low-traffic links get registered in the MAC address table of the switch 50. As a result, the network managing apparatus 100 can acquire information even on the low-traffic links from the MAC address table of the switch 50. Thus, the network managing apparatus 100 can obtain accurate topology information.

Although, only one router, i.e., the router 10, is shown in the network 1, there can be a plurality of routers. Moreover, each router in the network 1 can be directly connected to a plurality of operation LANs.

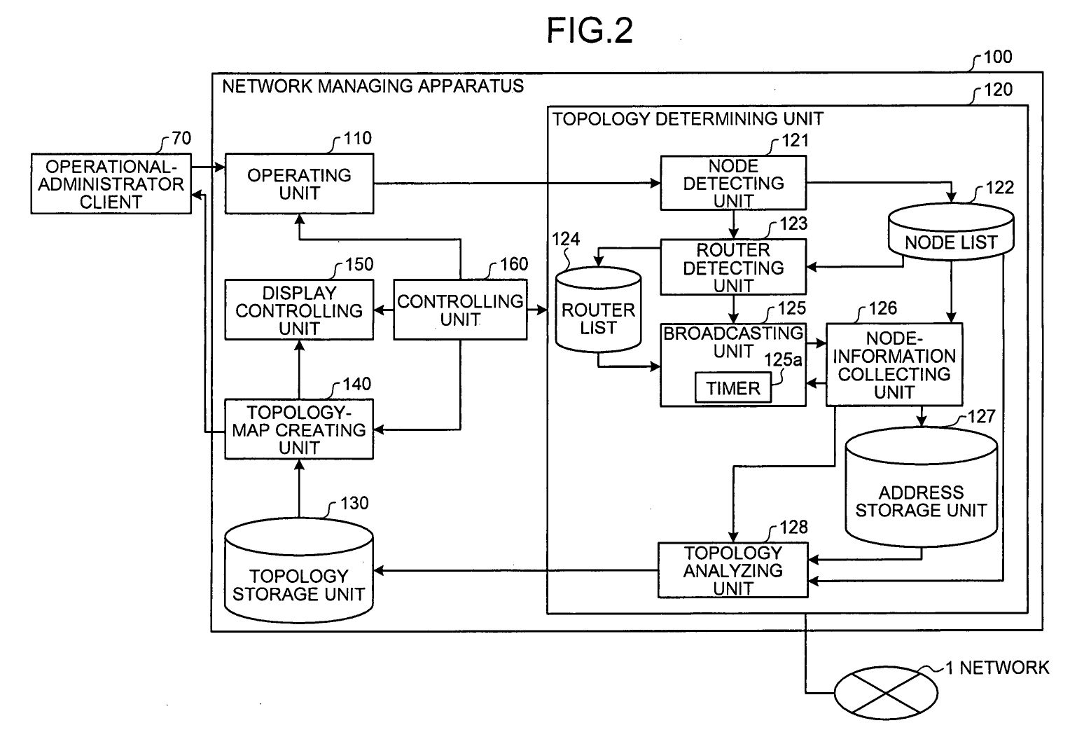

FIG. 2 is a detailed functional block diagram of the network managing apparatus 100. The network managing apparatus 100 includes an operating unit 110, a topology determining unit 120, a topology storage unit 130, a topology-map creating unit 140, a display controlling unit 150, and a controlling unit 160.

The operating unit 110 receives a request from the operational-administrator client 70 to collect topology information.

The topology determining unit 120 determines links between respective nodes in the network 1. The topology determining unit 120 includes a node detecting unit 121, a node list 122, a router detecting unit 123, a router list 124, a broadcasting unit 125, a node-information collecting unit 126, a address storage unit 127, and a topology analyzing unit 128.

The node detecting unit 121 detects nodes subjected to topology analysis in the network 1 mainly through the management LANs. The nodes can be routers, switches, or servers. The node detecting unit 121 registers detected nodes in the node list 122. The node list 122 stores therein information on the nodes detected by the node detecting unit 121.

The router detecting unit 123 detects one or more routers from among the nodes registered in the node list 122. More specifically, with reference to the value of a simple network management protocol/management information base (SNMP/MIB) object on each node registered in the node list 122, the router detecting unit 123 checks if the node has a function of performing Internet protocol (IP) forwarding. If the node has the function of performing Internet protocol (IP) forwarding, it means that the node has a routing function, i.e., the node is a router.

Specifically, the router detecting unit 123 detects one or more routers capable of using Telnet from among the detected routers and registers such routers in the router list 124. Thus, the router list 124 stores therein information only on the routers capable of using Telnet.

The broadcasting unit 125 remotely logs into each of the routers registered in the router list 124, and causes that router to send broadcast pings to a subnet directly connected to that router. The broadcasting unit 125 includes a timer 125a.

First, the broadcasting unit 125 remotely logs into any one router, say a first router, and obtains a routing table from the first router. Then, referring to the routing table of the first router, the broadcasting unit 125 checks the correspondence between the name of an interface directly connected to the first router and the IP address of a network (subnet) to which the interface is attached (hereinafter sometimes referred to as network address). To obtain a routing table from a router, for example, the broadcasting unit 125 sends the router a command as “# show ip route”.

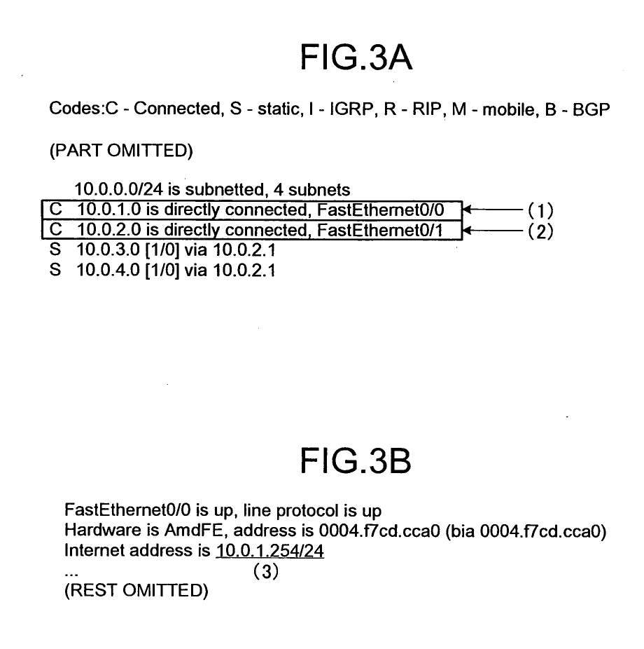

FIG. 3A is an example of contents of a typical routing table. Incidentally, the process described below uses only information about the correspondence between a network address and the name of an interface directly connected to the router. Therefore, part of the routing table not involved in the process is not shown in the drawing.

In FIG. 3A, the line whose first field contains C indicates the correspondence between a network address and the name of an interface directly connected to the router. For example, the line denoted by (1) indicates that an interface FastEthernet 0/0 is directly connected to a subnet with an address of 10.0.1.0. The line denoted by (2) indicates that an interface FastEthernet 0/1 is directly connected to a subnet with an address of 10.0.2.0.

The broadcasting unit 125 determines whether the IP address of a subnet is within the range of private addresses. If not, i.e., if the IP address is outside the range of private addresses, the broadcasting unit 125 immediately discards information about the subnet so that IP addresses on the Internet side are not to be designated in the following process.

The broadcasting unit 125 then obtains information about the interface through the first router. For example, to obtain information about the interface FastEthernet 0/0 shown in FIG. 3A, the broadcasting unit 125 executes a command as “# show interface FastEthernet 0/0”.

FIG. 3B is an example of the information about the interface FastEthernet 0/0 obtained by the command. In the part underlined and denoted by (3), the value of a subnet mask and an IP address assigned to the interface are represented in classless inter-domain routing (CIDR) notation.

The notation 10.0.1.254/24 means that an IP address 10.0.1.254 is assigned to the interface FastEthernet 0/0, and that, in a 32-bit IP address, the first 24 bits are 1, i.e., /24 is equivalent to a subnet mask of 255.255.255.0.

Accordingly, the corresponding subnet has an IP address in which all bits in the host portion, lower eight bits, are zero: 10.0.1.0. The broadcast address of the subnet is an IP address in which all bits in the host portion, lower eight bits, are 1: 10.0.1.255.

The broadcasting unit 125 causes the router to send broadcast pings to the address 10.0.1.255 as destination. Accordingly, the router sends a ping to all nodes in the subnet with the address 10.0.1.0.

In the same manner, the broadcasting unit 125 obtains information about the interface FastEthernet 0/1 shown in FIG. 3A, and controls the router to send broadcast pings to the subnet with the address 10.0.2.0.

The node-information collecting unit 126 collects information from the MAC address table of each switch in the network 1 as link information after the process performed by the broadcasting unit 125.

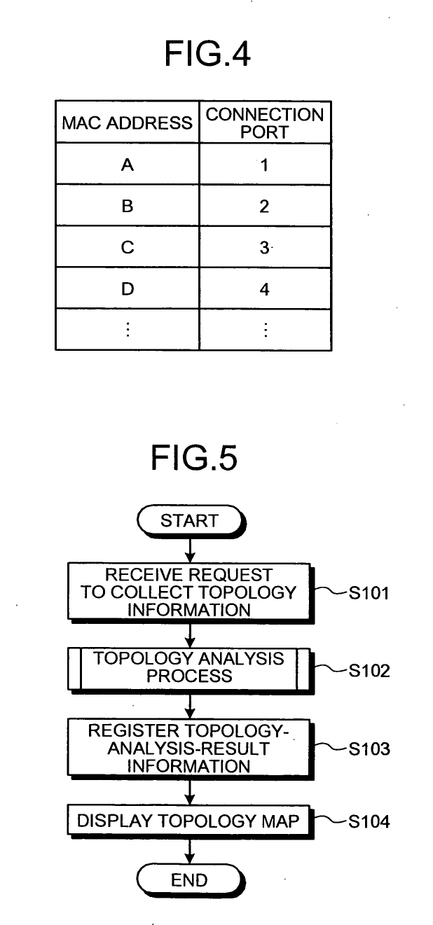

FIG. 4 is an example of contents of the MAC address table in the switch 50. When the switch receives a packet such as a ping, the MAC address of the sender node of the packet is associated with the port number of a connection port used to receive the packet. The MAC address table stores therein the associated pair.

In FIG.4, nodes with MAC addresses A, B, C and D correspond to the router 10, the server 20, the server 30 and the server 40, respectively (see FIG. 1). For example, the first line of the MAC address table indicates that the router 10 has a MAC address of A, and is connected to the switch 50 trough a connection port with port number 1.

Referring now to FIGS. 1 to 4, the operation of each node in the network 1, after the router sends a broadcast ping to the node under the control of the broadcasting unit 125, is explained.

The router 10 sends a ping to all other nodes in the network 1, i.e., the servers 20 to 40 and the switch 50. The servers 20 to 40 receive the ping via the switch 50.

Having received the pings from the router 10, the switch 50 associates the MAC address A of the router 10 with the port number 1 of a connection port connected to the router 10 to store the associated pair in the MAC address table (see FIG. 4). Thereby, the switch 50 learns that the connection port with port number 1 is connected to the router 10.

On receipt of the ping from the router 10 via the switch 50, the server 20 sends a ping reply to the router 10 along the same path that carried the incoming ping. In other words, the ping reply from the server 20 arrives at the router 10 via the switch 50.

Having received the ping reply from the server 20, the switch 50 associates the MAC address B of the server 20 with the port number 2 of a connection port connected to the server 20 to store the associated pair in the MAC address table (see FIG. 4). Thereby, the switch 50 learns that the connection port with port number 2 is connected to the server 20.

Similarly, ping replies from the servers 30 and 40 arrive at the router 10 via the switch 50. Having received the ping replies, the switch 50 associates the MAC address C of the server 30 with the port number 3 of a connection port connected to the server 30 and the MAC address D of the server 40 with the port number 4 of a connection port connected to the server 40, in the same manner as previously described for the server 20. The MAC address table stores therein the associated pairs (see FIG. 4). Thereby, the switch 50 learns that the connection port with port number 3 is connected to the server 30, and that the connection port with port number 4 is connected to the server 40.

As just described, under the control of the broadcasting unit 125, the router 10 sends a broadcast ping to the servers 20 to 40 via the switch 50. The servers 20 to 40 each return a ping reply to the router 10 via the switch 50. Thus, the switch 50 can learn the MAC addresses of the respective sender nodes without autonomously collecting link information.

On the other hand, if there is no communication with a node for the predetermined time period, information corresponding to the node is aged out of the MAC address table of the switch 50. Consequently, the node-information collecting unit 126 obtains information from the switch 50 before the information is aged out of the MAC address table. The node-information collecting unit 126 registers the information in the address storage unit 127. The address storage unit 127 stores therein the information in association with information that uniquely identifies the switch 50 as link information between the respective nodes present in the network 1. By this means, the network managing apparatus 100 can obtain accurate link information between the respective nodes connected via the operation LANs.

The topology analyzing unit 128 analyzes the topology of the network 1 based on the information contained in the node list 122, and the link information stored in the address storage unit 127.

The topology storage unit 130 stores therein information on the result of the topology analysis obtained by the topology analyzing unit 128. The topology-map creating unit 140 creates a topology map based on the topology-analysis-result information stored in the topology storage unit 130.

The display controlling unit 150 displays the topology map on the display screen of the operational-administrator client 70. The controlling unit 160 controls the operating unit 110, the topology determining 120, the topology-map creating unit 140, and the display controlling unit 150.

As described above, the router detecting unit 123 detects one or more routers capable of using Telnet from among nodes registered in the node list 122. The broadcasting unit 125 causes the routers to send a broadcast ping to the other nodes. Link information, such as the MAC address of each node that has returned a ping reply, is stored in the MAC address table of a switch. The node-information collecting unit 126 obtains the link information from the switch before the information is aged out of the MAC address table. Thus, it is possible to obtain information even on a low-traffic link from the switch.

When a considerable amount of time is required to collect link information due to a large number of nodes in the network 1, the node-information collecting unit 126 may not be able to collect the information from all switches before the information is aged out of the MAC address tables in some of the switches.

To avoid this, the broadcasting unit 125 causes the routers to send a broadcast ping to the other nodes repeatedly at regular intervals using the timer 125a while the node-information collecting unit 126 is collecting link information in the network 1.

In the following, the function of the timer 125a is explained in detail. The timer 125a starts counting time after the completion of the broadcasting process performed by the broadcasting unit 125. When detecting that a predetermined time period has elapsed, the timer 125a causes the broadcasting unit 125 to re-perform the broadcasting process.

The predetermined time period is set to less than the time for which information remains, without being aged out, in the MAC address table of each switch in the network 1. For example, if information is kept in the MAC address table for five minutes, the predetermined time period is set to less than five minutes, say four minutes. When detecting the elapse of four minutes, the timer 125a causes the broadcasting unit 125 to re-perform the broadcasting process.

Accordingly, the routers send again a broadcast ping to the respective nodes in the network 1. The ping and ping reply thereto also arrive at their destinations via a switch. Therefore, the time-out for aging information out of the MAC address table of the switch is reset. By repeating the broadcasting process, it is possible to prevent information stored in the switch from being aged out of the MAC address table while the node-information collecting unit 126 is performing the process.

On completion of the process by the node-information collecting unit 126, the timer 125a terminates the counting of time, and the broadcasting unit 125 stops the repetition of the broadcasting process.

In this manner, the timer 125a counts time during the process performed the node-information collecting unit 126. On elapse of a time period less than the time for which information remains, without being aged out, in the MAC address table of each switch, the timer 125a causes the broadcasting unit 125 to re-perform the broadcasting process. Thus, while the node-information collecting unit 126 is collecting link information from the MAC address tables of switches, the information is prevented from being aged out of the MAC address tables and is maintained in the switches.

FIG. 5 is a flowchart of a topology-map-creation process performed by the network managing apparatus 100. The operating unit 110 receives a request to collect topology information in the network 1 from the operational-administrator client 70 (step S101). In response to the request, the topology determining unit 120 performs a topology analysis process of checking links between respective nodes in the network 1 to analyze the topology of the network 1 (step S102). The topology determining unit 120 then registers information on the result of the topology analysis in the topology storage unit 130 (step S103). The topology-map creating unit 140 creates a topology map based on the result of the topology analysis stored in the topology storage unit 130. The display controlling unit 150 finally displays the created topology map on the display screen of the operational-administrator client 70 (step S104).

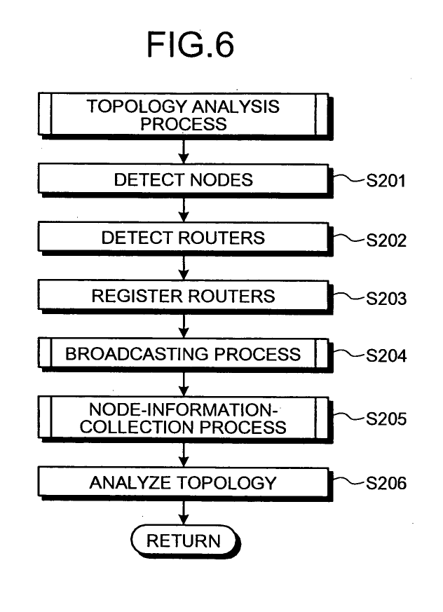

FIG. 6 is a detailed flowchart of the topology analysis process at step S102 in FIG. 5. The node detecting unit 121 detects the nodes in the network 1 mainly through the management LANs. The node detecting unit 121 registers information on the detected nodes in the node list 122 (step S201).

Although not shown in the drawing, in the topology analysis process, the topology determining unit 120 once allows the sending of a broadcast ping to the respective nodes in the network 1 in parallel with the node detection.

The router detecting unit 123 detects one or more routers from among the nodes registered in the node list 122 (step S202). Further, the router detecting unit 123 detects one or more routers capable of using Telnet from among detected routers and registers only those routers in the router list 124 (step S203).

The broadcasting unit 125 causes all the routers registered in the router list 124 to send a broadcast ping to the other nodes in the node list 122 (step S204). Thereby, the routers send a broadcast ping to all the other nodes in the network 1, and the nodes return a ping reply to the routers. The packets, ping and ping reply thereto, arrive at their destinations via a switch such as the switch 50. That switch temporarily stores the MAC address of a sender node in association with the port number of a connection port that received the packet in its MAC address table.

The node-information collecting unit 126 obtains the information from every switch before the information is aged out of the MAC address table, and registers the information in association with information that uniquely identifies the switch in the address storage unit 127 (step S205). Incidentally, during the collection of the link information, the broadcasting unit 125 performs the broadcasting process repeatedly at regular intervals.

The topology analyzing unit 128 analyzes the topology of the network 1 based on the information contained in the node list 122, and the information stored in the address storage unit 127 (step S206). Thereafter, the topology analysis process ends.

As described above, the router detecting unit 123 detects one or more routers capable of using Telnet from among nodes in the network 1, and the broadcasting unit 125 causes the routers to send a broadcast ping to other nodes. Link information, such as the MAC address of each node that has returned a ping reply, is stored in the MAC address table of at least one switch in the network. The node-information collecting unit 126 obtains the link information from the switch before the information is aged out of the MAC address table. Thus, it is possible to obtain information even on a low-traffic link from the switch.

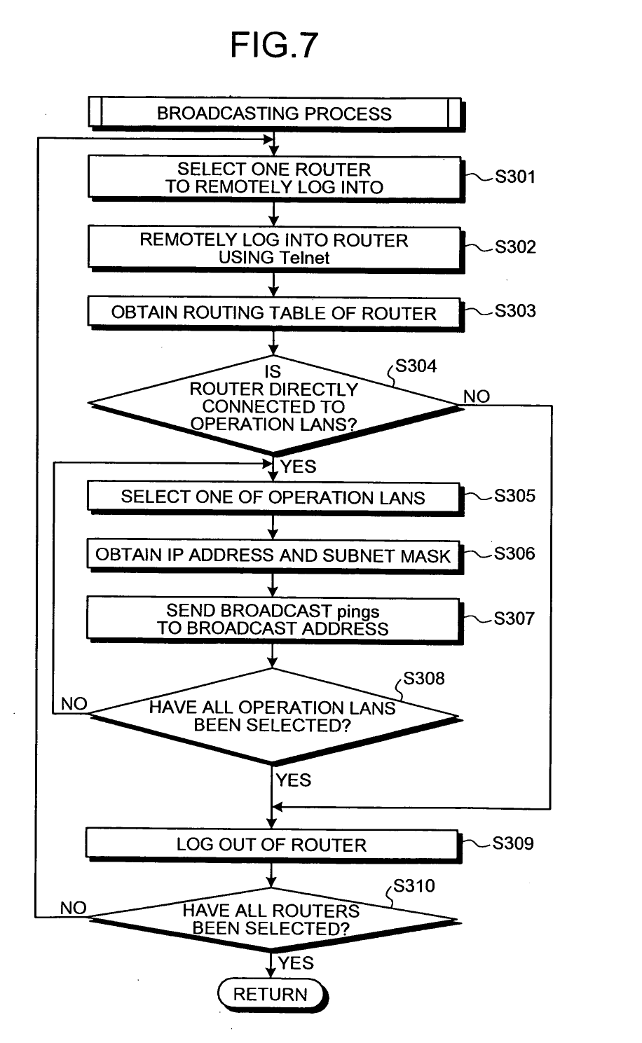

FIG. 7 is a detailed flowchart of the broadcasting process at step S204 in FIG. 6. The broadcasting unit 125 selects one of the routers registered in the router list 124 (step S301), and remotely logs into the router using Telnet (step S302).

The broadcasting unit 125 obtains a routing table from the router (step S303). Then, referring to the routing table, the broadcasting unit 125 determines whether the router is directly connected to one or more operation LANs (step S304). The determination can be made by, for example, registering a node that is connected only to the management LAN (such as the switch 60 in FIG. 1) in the network managing apparatus 100 in advance.

When the router is directly connected to a plurality of operation LANs (YES at step S304), the broadcasting unit 125 selects one of the operation LANs as an interface directly connected to the router (step S305), and obtains an IP address and subnet mask assigned to the interface (step S306).

Based on the IP address and subnet mask, the broadcasting unit 125 calculates the broadcast address of a subnet to which the interface is attached. The broadcasting unit 125 causes the router to send broadcast pings to the broadcast address as destination (step S307). The broadcast pings and ping replies thereto arrive at their destinations via a switch. The switch stores the MAC address of each sender node in association with the port number of a connection port connected to the switch in the MAC address table.

After that, the broadcasting unit 125 refers to the routing table of the router to determine whether all the operation LANs connected to the router have been selected (step S308). If not (NO at step S308), the process control returns to step S305, and the broadcasting unit 125 selects another operation LAN.

On the other hand, when all the operation LANs have been selected (YES at step S308), or the router is not directly connected to any operation LAN (NO at step S304), the broadcasting unit 125 logs out of the router (step S309), and terminates the process for the router.

Referring next to the router list 124, the broadcasting unit 125 determines whether all the routers in the router list 124 have been selected (step S310). If any router remains to be selected (NO at step S310), the process returns to step S301, and the broadcasting unit 125 selects another router. When all the routers have been selected (YES at step S310), the broadcasting unit 125 completes the broadcasting process.

Namely, under the control of the broadcasting unit 125, each router sends a broadcast ping to other nodes via a switch. The other nodes each return a ping reply to the router via the switch. Thus, the switch can learn the MAC addresses of the respective sender nodes.

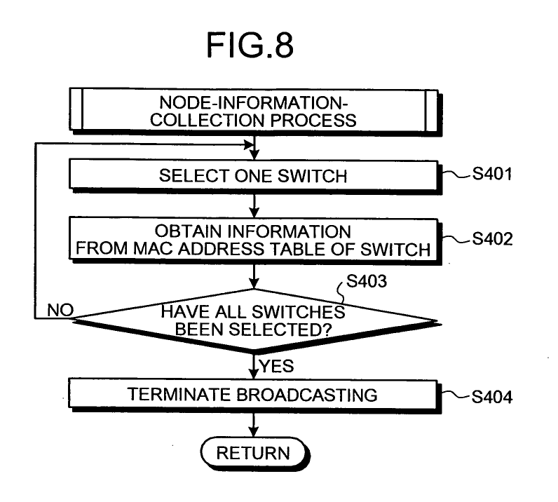

FIG. 8 is a detailed flowchart of the node-information collection process at step S205 in FIG. 6. While the node-information collection process is being performed by the node-information collecting unit 126, the broadcasting unit 125 performs in parallel the broadcasting process shown in FIG. 7 at regular intervals.

Referring to the node list 122, the node-information collecting unit 126 selects a switch from the nodes in the network 1 (step S401). The node-information collecting unit 126 obtains information stored in the MAC address table of the switch to register the information in association with information that uniquely identifies the switch in the address storage unit 127 (step S402).

The node-information collecting unit 126 determines whether all switches in the network 1 have been selected (step S403). If any switch remains to be selected (NO at step S403), the process returns to step S401. When all the switches have been selected (YES at step S403), the node-information collecting unit 126 causes the broadcasting unit 125 to terminate the broadcasting process (step S404).

More specifically, the node-information collecting unit 126 stops the timer 125a so that the broadcasting process shown in FIG. 7 is not performed any more. In addition, the node-information collecting unit 126 prohibits the sending of broadcast pings, which the topology determining unit 120 has once allowed in the process of the topology analysis. After that, the node-information collecting unit 126 completes the node-information collection.

That is, the broadcasting unit 125 performs the broadcasting process while the node-information collecting unit 126 is collecting link information. After the completion of the process performed by the node-information collecting unit 126, the broadcasting unit 125 terminates the broadcasting process. Thus, while the node-information collecting unit 126 is collecting the link information from the MAC address tables of switches, the information is prevented from being aged out of the MAC address tables and is maintained in the switches.

Thus, according to the embodiment, the router detecting unit 123 detects one or more routers capable of using Telnet from among the nodes in the network 1. The broadcasting unit 125 causes the detected router(s) to send a broadcast ping to the other nodes. Link information, such as the MAC address of each node that has sent pings or a ping reply, is stored in the MAC address table of a switch in the network 1. The node-information collecting unit 126 obtains the link information from the MAC address table of the switch before the information is aged out of the MAC address table. Thereby, it is possible to obtain information even on a low-traffic link from the switch. Thus, the network managing apparatus 100 can obtain accurate topology information.

The network managing apparatus 100 is explained above as hardware; however, it can be implemented as software. In other words, a computer program (hereinafter, a topology-information-collection program) can be executed on a computer to realize the same function as the network managing apparatus 100. In the following, such a computer is explained.

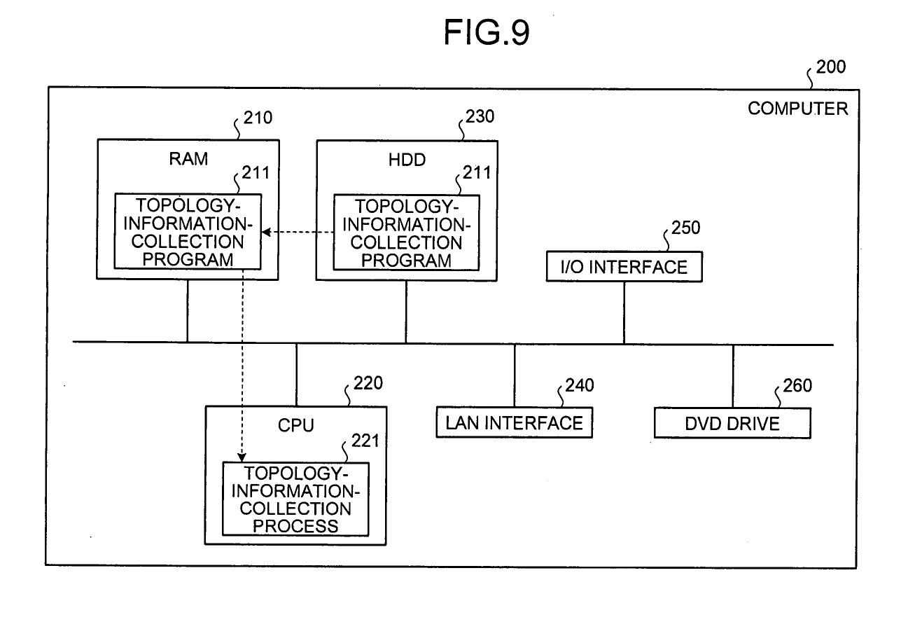

FIG. 9 is a detailed functional block diagram of a computer 200 that executes the topology-information-collection program. The computer 200 includes a random access memory (RAM) 210, a central processing unit (CPU) 220, a hard disk drive (HDD) 230, a local area network (LAN) interface 240, an input/output (I/O) interface 250, and a digital versatile disc (DVD) drive 260.

The RAM 210 stores a program, intermediate results of the execution of the program, and the like. The CPU 220 reads the program from the RAM 210 to execute the program.

The HDD 230 stores various programs and data. The LAN interface 240 connects the computer 200 to another computer via LAN. The I/O interface 250 is an interface to an input device, such as a mouse or a keyboard, and a display.

The DVD drive 260 performs writing to and reading from DVD. The DVD contains the topology-information-collection program 211 executed on the computer 200. The DVD drive 260 reads the topology-information-collection program 211 from the DVD to install the topology-information-collection program 211 in the computer 200.

The topology-information-collection program 211 can be stored in the database, etc. of another computer system connected to the computer 200 via the LAN interface 240. In this case, the topology-information-collection program 211 is read from the database to be installed in the computer 200.

The topology-information-collection program 211 is stored in the HDD 230. The topology-information-collection program 211 is loaded into the RAM 210 when required, and executed by the CPU 220 as a topology-information-collection process 221.

Incidentally, the above discussion pertains principally to the case where a router broadcasts ping packets. However, the present invention is not so limited and can be applied similarly to the case of broadcasting packets other than ping request that require a reply to the sender.

As set forth hereinabove, according to an embodiment of the present invention, it is possible to accurately obtain information even on a low-traffic link from an intermediate node.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer to collect information on the topology of a network including at least an intermediate node having an address table, which contains address information of substantially all nodes in the network, and from which is deleted address information of a node that has not performed communication for a predetermined time period, the nodes including at least one router, the computer program causing the computer to execute:
detecting a router from among the nodes;
causing detected router to broadcast, in the network, via the intermediate node echo-request packets each requiring an echo-reply packet so that the intermediate node stores in a corresponding address table address information of the detected router and address information of a sender node of an echo-reply packet; and
collecting address information from the address table of the intermediate node before the address information is deleted from the address table due to elapse of the predetermined time period.

2. The computer-readable recording medium according to claim 1, wherein the causing includes causing the detected router to broadcast the echo-request packets at regular intervals shorter than the predetermined time period.

3. The computer-readable recording medium according to claim 1, wherein, once address information is collected from every intermediate node in the network at the collecting, the causing the detected router to broadcast the echo-request packets is terminated.

4. The computer-readable recording medium according to claim 1, wherein the echo-request packets are broadcasted according to a packet internet groper (ping) command.

5. The computer-readable recording medium according to claim 1, wherein the detecting includes detecting a router capable of teletype network (Telnet) sessions.

6. The computer-readable recording medium according to claim 1, wherein the address information is a media access control (MAC) address assigned to each sender node.

7. A topology information collecting apparatus that collects information on the topology of a network including at least an intermediate node having an address table, which contains address information of substantially all nodes in the network, and from which is deleted address information of a node that has not performed communication for a predetermined time period, the nodes including at least one router, the topology information collecting apparatus comprising:
a router detecting unit that detects a router from among the nodes;
a broadcasting unit that causes detected router to broadcast, in the network, via the intermediate node echo-request packets each requiring an echo-reply packet so that the intermediate node stores in a corresponding address table address information of the detected router and address information of a sender node of an echo-reply packet; and
a node-information collecting unit that collects address information from the address table of the intermediate node before the address information is deleted from the address table due to elapse of the predetermined time period.

8. The topology information collecting apparatus according to claim 7, wherein the broadcasting unit causes the detected router to broadcast the echo-request packets at regular intervals shorter than the predetermined time period.

9. A method of collecting information on the topology of a network including at least an intermediate node having an address table, which contains address information of substantially all nodes in the network, and from which is deleted address information of a node that has not performed communication for a predetermined time period, the nodes including at least one router, the method comprising:
detecting a router from among the nodes;
causing detected router to broadcast, in the network, via the intermediate node echo-request packets each requiring an echo-reply packet so that the intermediate node stores in a corresponding address table address information of the detected router and address information of a sender node of an echo-reply packet; and
collecting address information from the address table of the intermediate node before the address information is deleted from the address table due to elapse of the predetermined time period.

10. The method according to claim 9, wherein the causing includes causing the detected router to broadcast the echo-request packets at regular intervals shorter than the predetermined time period.
